(19) United States
(12) Patent Application Publication
(10) Pub. No.: US 2017/0299467 A1
(43) Pub. Date: Oct. 19, 2017

(54) DEVICE FOR DETECTING SPEED OF A ROTATABLE ELEMENT, METHOD AND VEHICLE

(71) Applicant: Scania CV AB, Södertälje (SE)

(72) Inventors: Björn JOHANSSON, Älvsjö (SE); Sebastian ZAMANI, Stockholm (SE); Peter WANSÖLIN, Järna (SE)

(73) Assignee: SCANIA CV AB, Södertälje (SE)

(21) Appl. No.: 15/515,644

(22) PCT Filed: Oct. 7, 2015
(86) PCT No.: PCT/SE2015/051061

§ 371 Date: Mar. 30, 2017

(30) Foreign Application Priority Data
Oct. 23, 2014 (SE) 1451265-1

(51) Int. Cl. G01M 15/06; F02B 77/08; F02D 41/00; G01P 3/481

(52) U.S. Cl. CPC G01M 15/06; G01P 3/481; F02B 77/085; F02D 41/009

(57) ABSTRACT

A device for detecting and monitoring crank shaft rotary speed and position in a four stroke engine, wherein a first and a second sensor are arranged to sense passage of reference marks on a rotatable element or elements. The first sensor is a high precision sensor which is arranged to sense passage of reference marks on a crank shaft flywheel of the engine, and the second sensor is a low speed sensor which is arranged to sense passage of reference marks on the crank shaft flywheel or reference marks or a wheel being associated with a cam shaft of the engine. The invention also concerns a method and a vehicle.

### CROSS-REFERENCE TO RELATED APPLICATION(S)

This application is a national stage application (filed under 35 §U.S.C. 371) of PCT/SE2015/051061, filed Oct. 7, 2015 of the same title, which, in turn claims priority to Swedish Application No. 1451265-1 filed Oct. 23, 2014 of the same title; the contents of each of which are hereby incorporated by reference.

### FIELD OF THE INVENTION

The invention relates to a device for detecting and monitoring crank shaft rotary speed and position in a four stroke engine, wherein a first and a second sensor are arranged to sense passage of reference marks on a rotatable element or elements. The invention also relates to a method and a vehicle including such a device.

### BACKGROUND OF THE INVENTION

A four stroke engine typically includes a flywheel and a cam shaft wheel where the flywheel and thereby the crank shaft make two revolutions and the cam shaft wheel makes one revolution during an engine working cycle.

These wheels are typically provided with reference marks such as recesses—holes or protrusions—teeth etc. The reference marks can be detected by one or more sensor for determining the rotary speed and also the position of the crank shaft.

When a wheel rotates and for example a tooth passes a sensor, a signal or a pulse is generated. How the signal is generated and its characteristics depend on the type of sensor and most often one of two types of sensors: Hall effect sensors and inductive sensors is used.

Furthermore, the reference marks are normally positioned with even separation on the rotatable element except for where typically one reference mark (or in certain cases more than one reference mark) is left out at one position on the respective wheel. Detecting this particular place makes it possible to calculate the crank shaft position in the engine.

In order to be able to start the engine, it has to be synchronized which means that the engine control system (or engine management system (EMS)) must be informed about where it is in the working cycle or ignition cycle which is two flywheel/crank shaft revolutions or 720 flywheel/crank shaft degrees for a four stroke engine.

Having one single sensor associated with the flywheel makes it possible to find out the crank shaft angle of the engine but the system is still not informed about whether this angle is in the interval 0-360 degrees or 360-720 degrees.

It is possible to separate these two cases by providing more advanced logic for monitoring engine response which is previously known according to the background art.

Another alternative is to also position a sensor associated with a wheel being fixed to the cam shaft. Since such a cam shaft wheel only makes one revolution per working cycle, there do not have to be made any more complicated extra steps in such a case. Irrespective method, it is important to receive signals as quickly as possible which means at as low rotational speed as possible in order to be able to quickly synchronize the engine.

A growing trend is to turn off the engine more and more when engine power is not required for operation, when for example the vehicle is stopped at red light. The reason for this is to save fuel and to reduce air pollution during idle run. This trend, which is particularly accentuated in respect of hybrid vehicles, makes it necessary to be able to restart the engine fast and with as short delay as possible. This increases the requirements to quickly synchronize the engine.

The rotational speed signal is the most important signal in the engine control system and that signal is used for many engine control system functions and not only for fuel injection.

In order to optimize the combustion process it is also important to know the crank shaft angle with high precision. The reason for this is that the angle where fuel injection is initiated is essential for efficient combustion and engine operation.

A rotational speed of the motor is thus typically measured by reference marks being read by one or more sensors that are positioned adjacent to the rotatable element such as the flywheel. By analyzing the signals from the sensors, the engine control unit can calculate where the engine is in the ignition cycle, i.e. positioning of the engine, and calculate the present rotational speed of the engine.

In order to obtain high precision in positioning the rotatable element, there are required a great number of precision reference marks. The same is true in order to measure the rotational speed with little delay, i.e. a great number of precision reference marks are required.

The background art is associated with high costs and high demands for manufacturing accuracy in order to obtain high precision.

U.S. Pat. No. 4,335,599, US2012176070 and IN2008CH02422A can be mentioned as representatives of the background art.

### SUMMARY OF THE INVENTION

It is an aim of the present invention to provide a device and a method according to the above wherein the problems of the background art are addressed and the problems are at least reduced.

This aim is obtained in respect of a device according to the above in that the first sensor is a high precision sensor which is arranged to sense passage of reference marks on a crank shaft flywheel of the engine, and that the second sensor is a low speed sensor which is arranged to sense passage of reference marks on the crank shaft flywheel or reference marks or a wheel being associated with a cam shaft of the engine.

With the definition “high precision sensor” is meant a sensor being capable of providing accurate crank angle position with very good precision. In practice it has been found that existing high precision sensors unfortunately require relatively high passage speed (and thereby relatively high rotary speed) of a reference mark for it to be acceptably sensed in order to deliver reliable signals.

With the definition “low speed sensor” is meant a sensor being capable of providing an acceptable synchronization signal already at very low passage speeds and thereby already at relatively low rotary speed. It has further been found that low precision sensors intended here do not deliver sufficiently high precision positioning being required today and in particular in the near future for truly optimized combustion. This flaw is, however, considered to be acceptable in the overall context, since the low speed sensor allows very fast synchronizing, start and restart of the engine without unnecessary delay.

According to the inventive device, the combination of a “high precision sensor” with a “low speed sensor” provides advantages in that it is now possible to achieve fast synchronization and thereby quick start of the engine together with normal operation with highly optimized combustion.

In other words: combining these two types of sensors in one single system gives the advantage of increased precision at the same time as fast response already at low speeds.

Preferably the first sensor, the “high precision sensor”, is an inductive sensor. Also preferably the second sensor, the “low speed sensor”, is a Hall effect sensor or a magnetoresistive sensor.

The Hall effect sensor as well as the magnetoresistive sensor is characterized by providing a reasonably good signal already at low speeds but is sensitive to noise and also slightly imperfect when it comes to positioning indication accuracy.

The inductive sensor requires higher relative speed between the sensor and the reference mark and thus higher rotary wheel speeds in order to give good sensor response but is less noise sensitive and provides better positioning capabilities. The inductive sensor can also typically be made robust enough to withstand the conditions prevailing close to the engine.

Suitably the first and second sensors are connected to a control unit which is arranged to emit signals to a fuel injection system.

When both the first and the second sensors are associated with the flywheel, it is an advantage that the first and second sensors are pre-installed on a carrier member with determined mutual separation, and that the carrier member together with the first and second sensors is installable as an integral unit at a chosen position in association with the flywheel.

The pre-installation of the first and second sensors on the carrier member can be made with high precision on a specialized production line or by a subcontractor such that the production flow at the main production line is not disturbed or delayed by additional intricate working operations.

Instead it is possible to have a complete sensor package to be precision mounted on the engine on the production line in one single working operation instead of having to mount with precision a plurality of sensors on the engine at the production line.

According to this aspect of the invention, in order to maintain a previous precision afforded with one sensor, it is possible to reduce the number of reference marks by the number of sensors on the carrier member.

More sensors result in an increased amount of wires but one way of reducing wiring is to provide a circuit which adds the signals from the sensors to one single signal which however increases a complexity of the device according to the invention.

Instead of reducing the number of reference marks it is possible to maintain a high number of reference marks and instead obtain increased positioning accuracy.

Advantageously the first and second sensors are installed on the carrier member so as to be angularly phase-displaced in respect of the reference marks on the rotatable element. This means for example that when one of the first and the second sensors faces the middle of a reference mark, the other one of the first and the second sensors faces midway between two adjacent reference marks in order to increase precision as is discussed above.

In addition to the first and second sensors, it is within the scope of the invention to preinstall at least one further sensor on the carrier member for further increased accuracy or for making it possible to use fewer reference marks.

The reference marks are suitably recesses such as drilled holes or protrusions such as teeth etc.

The invention also concerns a method for detecting and monitoring crank shaft position in a four stroke engine, wherein a first and a second sensor senses passage of reference marks on a rotatable element or elements. The first sensor being a high precision sensor senses passage of reference marks on a crank shaft flywheel of the engine, and the second sensor being a low speed sensor senses passage of reference marks on the crank shaft flywheel or reference marks on a wheel being associated with a cam shaft of the engine.

The first sensor preferably senses reference marks inductively and the second sensor preferably senses reference marks through the Hall effect or through magnetoresitive effect.

Signals from the first and second sensors are advantageously led to a control unit which emits signals to a fuel injection system for synchronized fuel injection.

The method preferably includes the steps of pre-installing the first and second sensors with determined mutual separation on a carrier member, and installing the carrier member as an integral unit at a chosen position in association with the flywheel.

Preferably the carrier member is bent or curved so as to conform to a form of the flywheel.

The invention also relates to a vehicle including a device according to the above.

### BRIEF DESCRIPTION OF THE DRAWINGS

The invention will now be described in greater detail by way of embodiments and with reference to the annexed drawings, wherein:

FIG. 1 shows a first variant of the invention in connection with a flywheel,

FIG. 2 shows a second variant of the invention,

FIG. 3 shows a third variant of the invention,

FIG. 4 shows diagrammatically the invention installed for cooperation with a flywheel of an internal combustion engine, and

FIG. 5 shows diagrammatically a vehicle equipped with an inventive device.

### DETAILED DESCRIPTION OF THE INVENTION

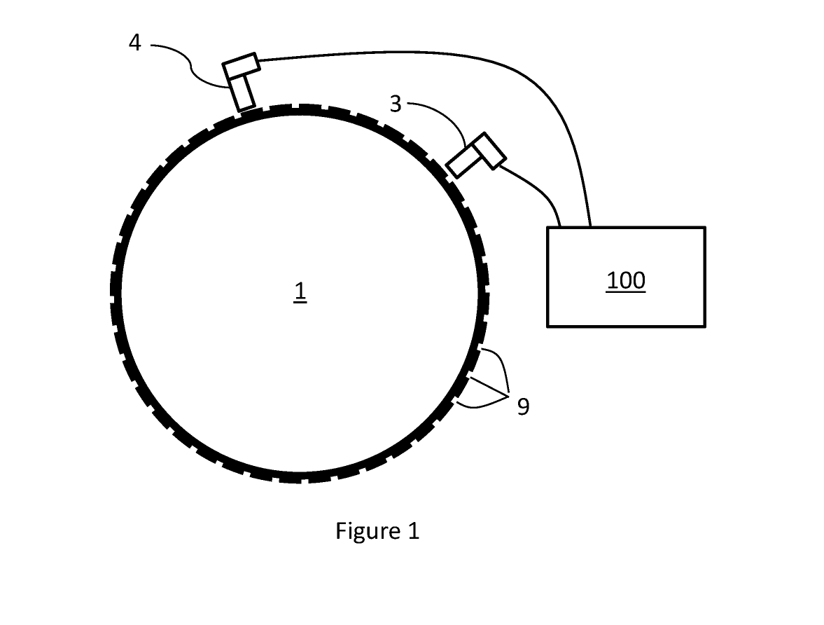

FIG. 1 illustrates the invention in connection with a rotatable element in the form of a flywheel 1 of an internal four stroke combustion engine. The flywheel 1 has a plurality of reference marks 9 distributed around its circumference. In the shown example, the reference marks 9 are surface recesses such as holes drilled in an envelope surface of the flywheel 1.

A first sensor 3 and a second sensor 4 are arranged to sense passage of the reference marks 9 and to issue signals to a control unit 100.

The first sensor 3 is high precision sensor being an inductive sensor which senses the reference marks 9 inductively so as to obtain high positioning precision. The second sensor 4 is a low speed sensor which senses reference marks 9 through the Hall effect or through magnetoresitive effect already at very low rotary speeds.

Signals from the first and second sensors are led to the control unit 100 which emits signals to a fuel injection system for synchronized fuel injection.

In order to obtain information about where in the 720° working cycle the engine is so as to obtain full synchronization, the device in FIG. 1 is advantageously supplemented for example with a sensor sensing cam shaft position (not shown) or more sophisticated logic evaluating engine response e.g. to fuel injections (not shown). This is previously known in the art and therefore not explained further here.

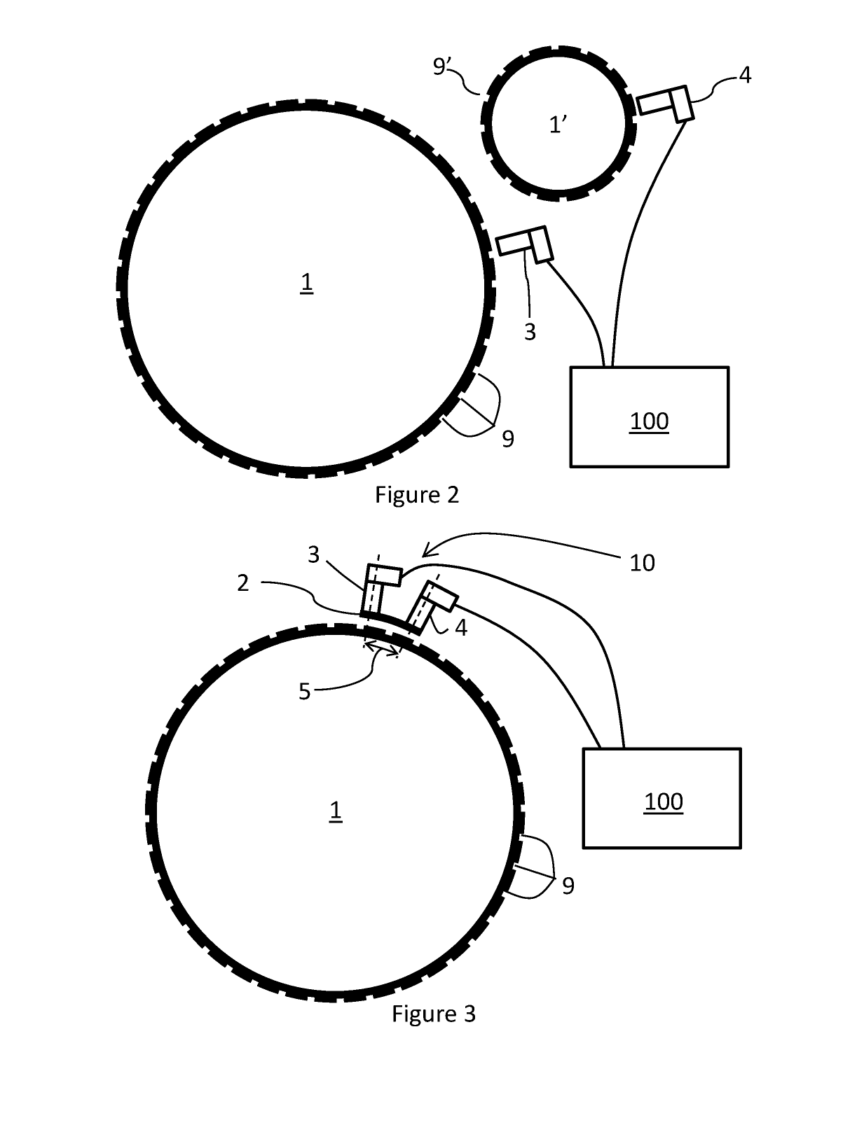

FIG. 2 illustrates a variant of the invention wherein a first sensor 3 being a high precision sensor is arranged in association with the flywheel 1 to sense passage of the reference marks 9 and to issue signals to a control unit 100. A second sensor 4 being a low speed sensor is in this embodiment instead associated with a wheel 1′ which is coupled to a cam shaft of the engine in question.

In order to obtain high quality positioning, the first sensor 3 is also in this case arranged to sense the reference marks 9 on the flywheel because of the rotational stability thereof which is explained with the high weight and high moment of inertia.

The second sensor 4 is also in this case a low speed sensor which with reasonable quality senses reference marks 9′ through the Hall effect or through magnetoresitive effect already at very low rotary speeds. The signals from the second sensor will be used for quick synchronization and for that purpose, cooperation with the cam shaft wheel, which has lower rotational stability than the flywheel, is sufficient.

In FIG. 3, 10 indicates an integral sensor unit including a carrier member 2 which carries a first sensor 3, a high precision sensor being an inductive sensor and a second sensor 4. The second sensor 4 is a low speed sensor which senses reference marks 9 on the flywheel 1 through the Hall effect or through magnetoresitive effect already at very low rotary speeds.

The integral sensor unit 10 is assembled in advance which means that the first and second sensors 3, 4 are preinstalled on the carrier member 2 while carefully attending to obtaining a determined distance between the first and the second sensors. The first 3 and second 4 sensors are connected to the control unit 100.

A separation 5 between the first sensor 3 and the second sensor 4 can be such that when the second sensor 4 faces a reference mark 9, the centre of the first sensor 3 is exactly between two adjacent reference marks. This way it is possible to obtain the better precision as if having one single sensor and the same number of reference marks.

It is also possible to position two sensors so as to simultaneously face and detect a reference mark.

The carrier member 2 is preferably bent or curved so as to as closely as possible adapt to a circumference of the flywheel 1, thereby allowing the sensors to come close to the flywheel 1.

In practice the integral sensor unit 10 can be precision mounted on a flywheel housing with a recess into which the integral sensor unit 10 can be inserted, possibly so as to be adjustable in a rotational direction of the flywheel.

The carrier member 2 can also be arranged to support more than two sensors for increase precision.

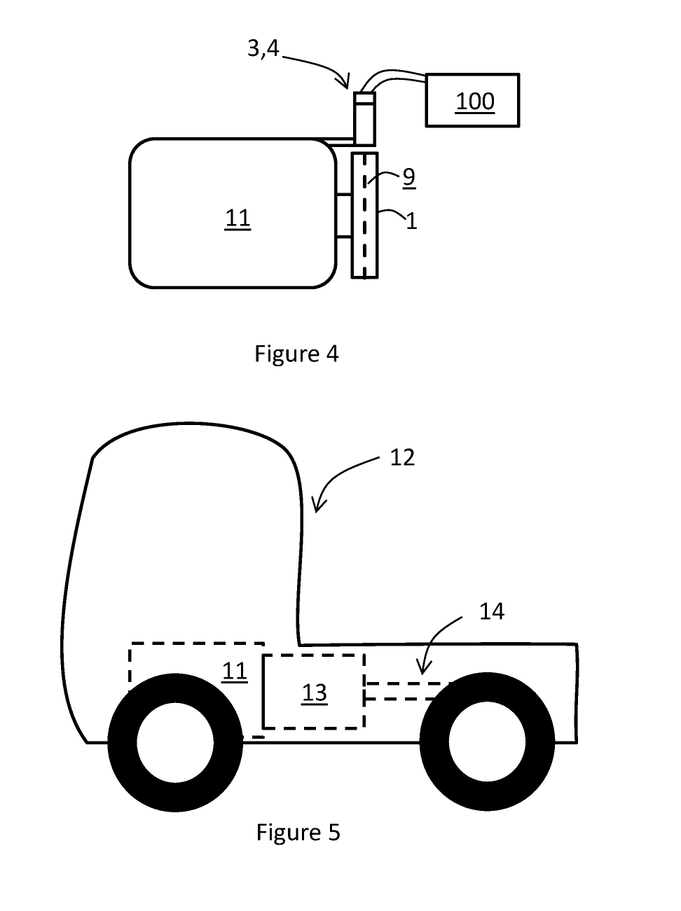

FIG. 4 illustrates the invention in connection with a four stroke internal combustion engine 11 having a flywheel 1 with reference marks 9 and the first 3 and second 4 sensors connected to the control unit 100.

FIG. 5 shows diagrammatically a vehicle 12 having a four stroke internal combustion engine 11 equipped according to the invention. 13 indicates a gear box and 14 a drive line.

1. A device for detecting and monitoring crank shaft rotary speed and position in a four stroke engine, said device comprising:
a first and a second sensor are arranged to sense passage of reference marks on a rotatable element or elements, wherein
the first sensor is a high precision sensor which is arranged to sense passage of reference marks on a crank shaft flywheel of the engine, and
the second sensor is a low speed sensor which is arranged to sense passage of reference marks on the crank shaft flywheel or reference marks or a wheel being associated with a cam shaft of the engine.

2. A device according to claim 1, wherein the first sensor is an inductive sensor.

3. A device according to claim 1, wherein the second sensor is a Hall effect sensor or a magnetoresitive sensor.

4. A device according to claim 1, wherein the first and second sensors are connected to a control unit which is arranged to emit signals to a fuel injection system.

5. A device according to claim 1, wherein
the first and second sensors are pre-installed on a carrier member with determined mutual separation, and
the carrier member together with the first and second sensors is installable as an integral unit at a chosen position in association with the flywheel.

6. A device according to claim 1, wherein the reference marks are recesses or protrusions.

7. A method for detecting and monitoring crank shaft position in a four stroke engine, wherein a first and a second sensor senses passage of reference marks on a rotatable element or elements, wherein
the first sensor being a high precision sensor senses passage of reference marks on a crank shaft flywheel of the engine, and
the second sensor being a low speed sensor senses passage of reference marks on the crank shaft flywheel or reference marks on a wheel being associated with a cam shaft of the engine.

8. A method according to claim 7, wherein reference marks on the wheel being connected to a camshaft for valve control are sensed by the second sensor.

9. A method according to claim 7, wherein reference marks on the flywheel are sensed also by the second sensor.

10. A method according to claim 7, wherein the first sensor senses reference marks inductively.

11. A method according to claim 7, wherein the second sensor senses reference marks through the Hall effect or through magnetoresitive effect.

12. A method according to claim 9, wherein signals from the first and second sensors are led to a control unit which emits signals to a fuel injection system for synchronized fuel injection.

13. A method according to claim 9, further comprising:
pre-installing the first and second sensors with determined mutual separation on a carrier member; and
installing the carrier member together with the first and second sensors as an integral unit at a chosen position in association with the flywheel.

14. A vehicle comprising a device for detecting and monitoring crank shaft rotary speed and position in a four stroke engine, said device comprising:
a first and a second sensor are arranged to sense passage of reference marks on a rotatable element or elements, wherein
the first sensor is a high precision sensor which is arranged to sense passage of reference marks on a crank shaft flywheel of the engine, and
the second sensor is a low speed sensor which is arranged to sense passage of reference marks on the crank shaft flywheel or reference marks or a wheel being associated with a cam shaft of the engine.

15. A vehicle according to claim 14, wherein the first sensor is an inductive sensor.

16. A vehicle according to claim 14, wherein the second sensor is a Hall effect sensor or a magnetoresitive sensor.

17. A vehicle according to claim 14, wherein the first and second sensors are connected to a control unit which is arranged to emit signals to a fuel injection system.

18. A vehicle according to claim 14, wherein
the first and second sensors are pre-installed on a carrier member with determined mutual separation, and
the carrier member together with the first and second sensors is installable as an integral unit at a chosen position in association with the flywheel.

19. A vehicle according to claim 14, wherein the reference marks are recesses or protrusions.
